(19) United States
(12) Patent Application Publication
(10) Pub. No.: US 2021/0280015 A1
(43) Pub. Date: Sep. 9, 2021

(54) SYSTEMS AND DEVICES FOR PRESENTING AND PLAYING GAMING EVENTS

(71) Applicant: Tina Grazioso, Las Vegas, NV (US)

(72) Inventor: Tina Grazioso, Las Vegas, NV (US)

(21) Appl. No.: 17/175,460

(22) Filed: Feb. 12, 2021

Related U.S. Application Data
(60) Provisional application No. 62/985,998, filed on Mar. 6, 2020.

(51) Int. Cl. G07F 17/32

(52) U.S. Cl. CPC G07F 17/3267; G07F 17/3293; G07F 17/3244

(57) ABSTRACT

Systems and devices are configured to present a game having multiple wagering opportunities, including ante and play wagers relative to a base portion of the game, and one or more optional side wagers. In the game, sets of cards are dealt to the player and dealer (such as seven cards) and the outcome of the base portion of the game is determined solely with reference to the “Straight” hand that the player and dealer can form from their sets of cards, wherein both the player and dealer may be required to have qualifying hands. Any side wagers placed by the player are resolved regardless of the outcome of the base portion of the game.

### CROSS-REFERENCE TO RELATED APPLICATION(S)

This application claims priority to and incorporates by reference U.S. Provisional Application No. 62/985,998, which was filed on Mar. 6, 2020.

### FIELD OF THE INVENTION

The present invention relates to gaming equipment and methods of presenting and playing games.

### BACKGROUND OF THE INVENTION

Game players are constantly seeking new and exciting games. Of course, a nearly infinite number of game variations can be created. A significant problem, however, is that most games are not viable for one or more reasons that are generally dependent upon the nature or type of the game and its players. For example, for a wagering game to be viable, it may need to satisfy a large number of criteria, including but not limited to: 1) being easy to learn; 2) being easy to play; 3) having a relatively high speed of play; 4) having odds of winning and payouts that entice the player to wager; and 5) having a sufficient “hold” to the house to make the game profitable to offer, among others. Unfortunately, very few games meet these criteria.

### SUMMARY OF THE INVENTION

Embodiments of the invention comprise gaming devices and systems for implementing games and methods of playing and presenting the games.

In one embodiment, games are implemented via specially configured gaming devices or systems. In other embodiments, games are played using game pieces, such as physical or virtual game pieces such as playing cards, such as at a specially configured table that includes game layout for use in implementing the game.

In one embodiment of presentation of a game, a player places an Ante wager and, optionally, one or more side wagers. An initial set of cards is dealt to each player as player cards, and dealt to the dealer as dealer cards, such as seven (7) initial cards to each player and the dealer. In one embodiment, an initial set of cards are dealt as community cards, such as three (3) initial cards.

In one embodiment, after the initial sets of cards are dealt, the player may elect to fold or continue play by placing a Play wager. In one embodiment, the Play wager must be larger than a specified minimum wager amount, or smaller than a specified maximum wager amount. In a preferred embodiment, the player's play wager must be larger than the player's Ante wager by a specified amount. In one embodiment, the cards in the set of player cards must comprise a qualifying hand, such as a Straight of at least two (2) cards, in order for the player to continue and to place the Play wager (otherwise the player folds and loses their Ante wager).

In one embodiment, an outcome of the base game, e.g. resolution of the player's Ante and Play wagers, is determined solely with reference to a player hand comprising the highest ranking Straight that can be formed from the player cards and with reference to a dealer hand comprising the highest ranking Straight that can be formed from the dealer cards.

In one embodiment, the outcome of the game depends at least in part upon whether the dealer hand qualifies. In one embodiment, the dealer qualifies if the dealer's cards form a 3-card Straight hand of a minimum rank.

If the dealer does not qualify, then each player who did not fold may be declared a winner of the game and be paid a first award.

If the dealer hand does qualify, then each player who did not fold is paid a second award if their hand outranks the dealer's hand (e.g. the Straight comprising the player's hand outranks the Straight comprising the dealer's hand), and the outcome may be declared a push if the Straight of the player's hand is the same as that of the dealer's hand. In the event the player's hand does not tie or beat the dealer's hand, the outcome is losing as to the player and the dealer may collect the player's ante wager and play wager.

Regardless of whether the player folded or did not fold, any side wagers placed by the player are resolved. In one embodiment, a side wager may comprise a wager that the cards in the set of player cards comprise a Straight Flush hand of a minimum number of cards, such as three (3) or more cards for an award of a fixed amount, or four (4) or more cards for a progressive award. In another embodiment, a side wager may comprise a Second Chance Straight Flush side wager that any combination of the player cards and the community cards comprise a Straight Flush hand of a minimum number of card, such as three (3) cards.

The games of the invention may be presented via an electronic gaming device or system, such as by displaying graphical images of game pieces. The games of the invention may also be presented at a game table using physical playing cards, chips, and a game table layout.

Further objects, features, and advantages of the present invention over the prior art will become apparent from the detailed description of the drawings which follows, when considered with the attached figures.

### DESCRIPTION OF THE DRAWINGS

FIG. 1 illustrates one embodiment of a game table and associated game layout for playing and presenting a game of the invention;

FIG. 2 illustrates one embodiment of a gaming system in accordance with the invention;

FIG. 3 is a flow chart which illustrates one method of playing and/or presenting a game in accordance with the invention; and

FIG. 4 illustrates one embodiment of a gaming machine for presenting a game in accordance with the invention.

### DETAILED DESCRIPTION OF THE INVENTION

In the following description, numerous specific details are set forth to provide a more thorough description of the present invention. It will be apparent, however, to one skilled in the art, that the present invention may be practiced without these specific details. In other instances, well-known features have not been described in detail so as not to obscure the invention.

Embodiments of the invention comprise devices and systems for presenting games, and methods of playing and presenting games, and particularly a card game in which an object of the game is for the player to achieve the highest possible Straight hand (cards having a sequential rank).

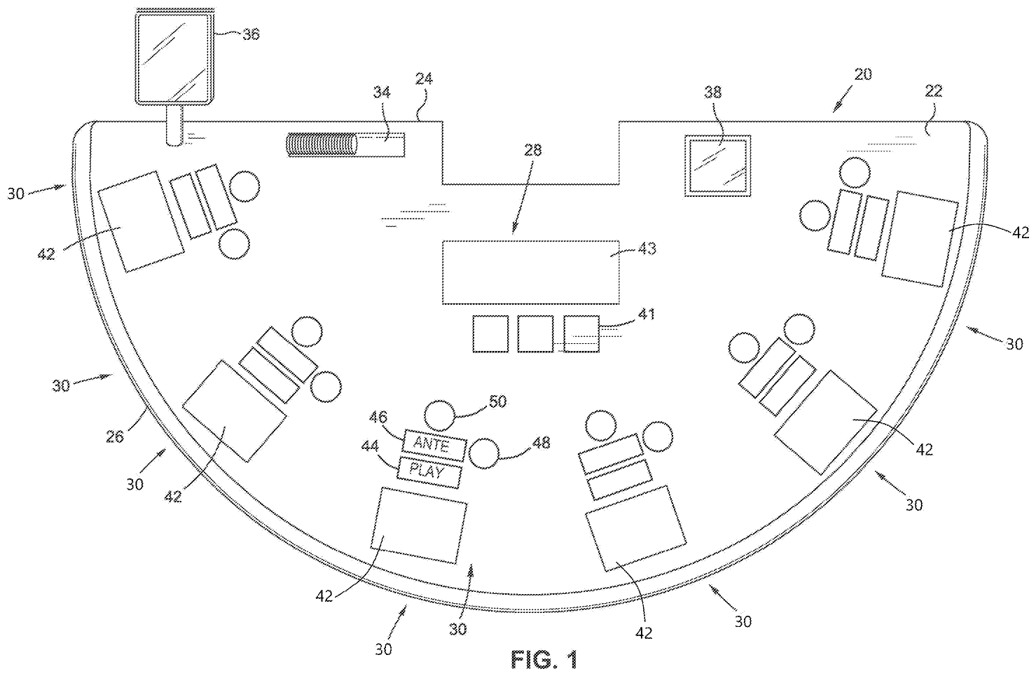

One aspect of the invention comprises equipment for presenting and playing a game, such as a specially configured gaming machine or a uniquely configured game table. FIG. 1 illustrates one embodiment of the invention, which is a game table 20 comprising a playing surface 22. The game table 20 may include one or more supports, such as a base, legs, or the like (not shown) via which the playing surface 22 is elevated above a supporting surface such as a gaming floor.

The shape of the playing surface 22 may vary. In one embodiment, the game table 20 has a rear having a rear edge 24 which is generally straight, and an opposing front having a front edge 26 which is generally arcuate. A bumper or cushion may be located at either or both edges 24,26.

In one embodiment, the playing surface 22 is generally planar. However, the playing surface 22 could have one or more raised areas and/or one or more depressed areas or other features integrated into the table or added to the table, such as by being located on or mounted to the top surface thereof. Various game-related information or features are preferably associated with the game table 20. In one embodiment, the playing surface 22 comprises a gaming felt or similar element(s) which are located over a substrate, such as a planar support. The gaming felt may bear game play information or other information, such as by printing on the felt. This information may vary, such as depending upon the game or games which are to be implemented at the game table 20, such as game rules, pay tables, and other game information. Printing on the gaming felt may further comprise one or more pay tables, player card locations 42 (e.g. one or more designated areas at or into which one or more cards may be dealt), a dealer card location 43, and a community card location 41.

In one embodiment, the information printed on the gaming felt also defines a dealer station 28 and one or more player positions 30. The dealer station 28 is generally located at the rear edge 24 and the player positions 30 are located opposite the dealer station 28 along the front edge 26. The dealer may, for example, stand adjacent to the dealer station 28. A player may stand or sit adjacent to each player position 30.

In one embodiment, the game which is presented at the game table 20 comprises a wagering game. Wagers may be placed using physical gaming chips or other elements. In one embodiment, the game table 20 may define one or more wagering areas. For example, as described below relative to a game of the invention, such wagering locations may comprise an Ante wager area 46, a Play wager area 44, and one or more side wager areas 48, 50. These areas may be defined on the game table 20, such as by printing on a felt surface thereof and/or via raised or depressed areas or other physical features, and such as in conjunction with each player position 30.

In another embodiment, wagers may be recorded by detecting the association of one or gaming chips (or monies or other wagering implements) with one or more input receiving devices or input sensors 32. The input receiving devices or input sensors 32 might comprise wired or wireless buttons, or other input devices, including RFID chip readers, proximity sensors, and other types of sensors. The input receiving devices 32 may be located in or on the game table 20 and are configured to detect inputs, such as provided by players at the playing surface 22. In the case of proximity sensors, the sensors may be any type of proximity sensor now known or later developed, such as IR, acoustic, capacitive, or the like.

In one embodiment, one or more input receiving devices 32 are associated with each player position 30, thereby providing a means for each player to provide input relative to game play at the game table 20 (and whereby the wagers of each player may be distinguished from those of the other players). For example, a different input receiving device 32 might be associated with each different wagering area, whereby wagers placed by a player relative to one or more different wagering areas may be independently detected.

In one embodiment, the dealer station 28 may include one or more chip trays 34 located on or at the game table 20 for storing chips, which may be used to pay player winnings and/or collected from player wagers.

In one embodiment, the game table 20 may include a number of other features. For example, the game table 20 may include one or more table displays 36. The table display 36 may comprise an electronic video display (such as an LCD, LED, OLED, DLP, or other types of displays which are now known or later developed) and/or a mechanical and/or electro-mechanical display device such as one or more spinning wheels or reels. The table display 36 may be located at or near the game table 20 for use in displaying game-related information such as pay table information, game status information, game outcome information, bonus information, or the like. The table display 36 might also be used to display promotional information or advertising. In one embodiment, the table display 36 displays the payouts for winning bet outcomes of the present invention.

The game table 20 might also comprise or include various input devices and/or other display devices. The input devices might include one or more dealer input devices such as one or more buttons or a dealer touchscreen display 38. For example, the dealer display 38 might comprise a display to display game-related information to the dealer and allows the dealer to provide various inputs.

Of course, various other types of input and display devices might be associated with the game table 20. The game table 20 might also include player touch-screens, input buttons, or the like.

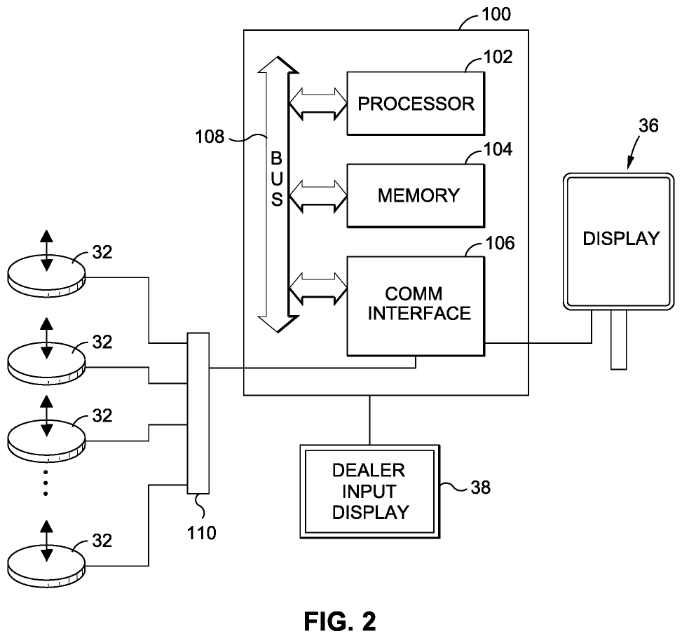

FIG. 2 illustrates additional details of one embodiment of the game table 20 where elements of the game table 20 are associated with or connected to at least one table controller 100. The table controller 100 may be located at the game table 20 or may be detachable.

In one embodiment, the table controller 100 comprises at least one processor 102 which is configured to execute machine-readable code fixed in a tangible medium (e.g. “software”). The table controller 100 may also comprise one or more information or data storage devices 104. These data storage devices 104 may comprise any type of data storage device such as ROM, RAM, EPROM, or the like, as well as mass storage devices such as hard drives. The data storage devices 104 may store various data, including game code or software which is executable by the processor(s) 102 and other data, such as game data including wager data, game outcome data, images, etc.

The table controller 100 preferably includes one or more communication interfaces 106. The communication interface(s) 106 may facilitate wireless and/or wired communications with one or more remote systems or devices following various protocols (USB, Wi-Fi, Bluetooth, Ethernet, Firewire, etc.). In one embodiment, data or information may be exchanged between the processor(s) 102, data storage device(s) 104, and communication interface(s) 106 via one or more interfaces, such as a system bus 108. Of course, the table controller 100 might have other configurations, including other elements or features.

As illustrated in FIG. 2, the one or more input receiving devices 32 of the game table 20 may be interfaced with the table controller 100 to that the table controller 100 may receive information from those devices 32 and, in some embodiments, to transmit information to those devices. Likewise, the dealer input and/or display devices, such as the dealer touchscreen 38, may be interfaced to the table controller 100. Also, other input and/or display devices such as the table display 36 may be interfaced to the table controller 100.

In one embodiment, the table controller 100 or other devices associated with the game table 20 may determine a player's monetary or chip value balances, including based upon monies associated with the table by the player (such as chips purchased), amounts wagered, and amounts won or the like.

The game table 20 of the invention may include or be associated with other elements or devices. For example, the game table 20 might include other gaming equipment, such as one or more player displays, such as one or more video displays or other display devices (such as located at each player position 30 and configured to display game information, player tracking information, advertising, or other information), card shoe(s), card reader(s), card shuffler(s), player tracking devices (such as for reading a player tracking card or other media of a player for use in tracking the player's gameplay) and the like. The game table 20 might also be connected to external devices. For example, the table controller 100 might be connected to one or more casino servers or systems, such as a casino accounting server that tracks gameplay at each game table 20, such as relative to the amounts of wagers placed and winnings paid to the players, among other information. The game table 20 might also be connected to a player tracking server and include player tracking elements such as player card readers.

The gaming system might include other elements, such as input receiving device controllers or the like. In one embodiment, the input receiving devices 32 communicate with a hub or aggregator 110 which communicates with the table controller 100. The hub 110 may be configured to read or determine the status of each input receiving device 32 and provide information to the table controller 100, such as when the status of an input receiving device 32 changes. The hub 110 may also comprise a power source for the input receiving devices 100. As another example, a proximity-type input sensor might be configured as a USB type device having a USB controller. The table controller 100 may be configured to control the proximity device as a USB device. In this regard, the processor 102 and/or one or more sub-processors or controllers may be utilized to control the input receiving devices.

In one embodiment of the invention, different input devices 32 might be utilized for receiving different inputs (such as one input device for receiving a wager input and another input device for receiving a “spin” input or the like). In another embodiment, the one or more input receiving devices 32 are configured to receive multiple inputs.

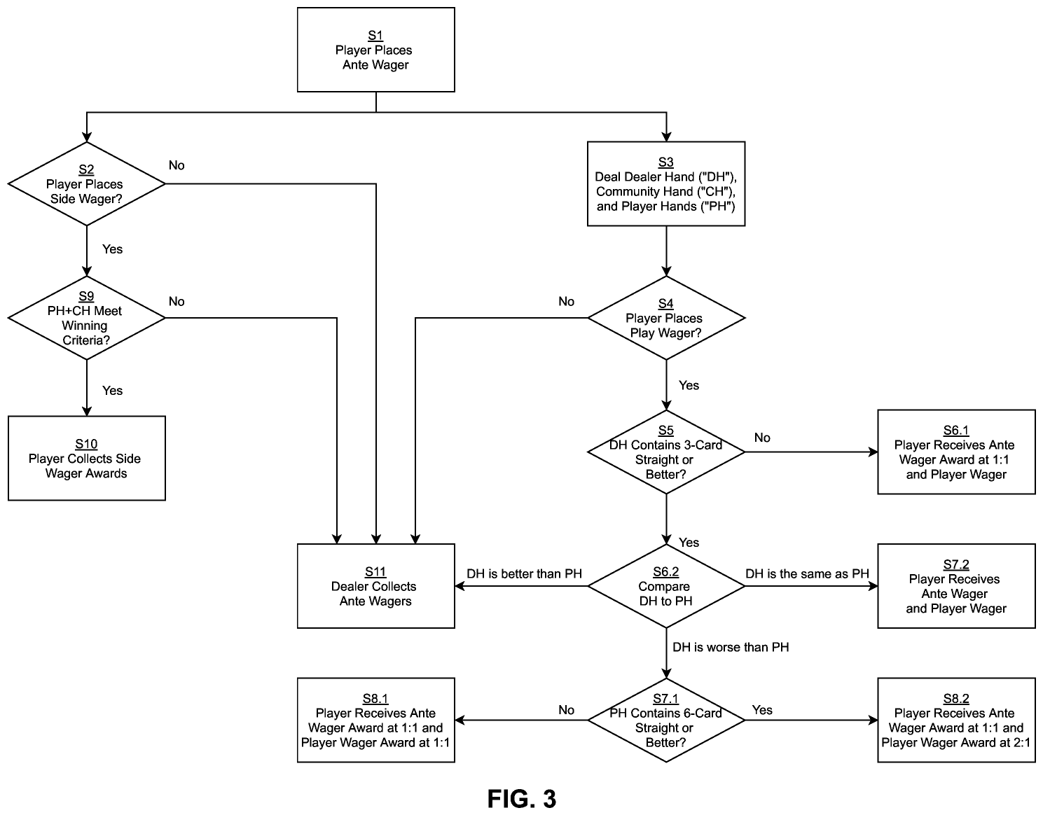

Additional details of methods, devices, and systems of the invention will now be described. FIG. 3 illustrates one embodiment of the invention to present and play a game. The game might be played or presented at a gaming machine or device, at a game table, or the like. In a preferred embodiment, the game is played at a game table by a dealer and at least one player, such as up to 6 or 7 players or more.

Preferably, the game is presented as a wagering game in which a player is required to place at least one wager to play the game and where the player has the opportunity to be awarded winnings. Thus, in one embodiment, a player places at least one wager, such as an Ante wager (step S1). In one embodiment, the player may be permitted (but is not required) to place one or more optional side wagers by placing one or more side wagers (step S2). As described below, such side wagers may comprise one or more of a Second Chance Straight Flush wager, a Straight Flush wager, or a Straight Flush Progressive wager.

In one embodiment, a player places one or more chips, coins, or the like at the wager location corresponding to the wager(s) they would like to place (such as the Ante wager location 46, the player wager location, 44, or one of the side wager locations 48, 50), such as by locating the one or more chips or the like in proximity to the one or more sensors for detection thereby. Each wager may be required to be of a certain minimum size and/or a maximum size.

When the player finished placing all wagers, cards will be dealt, such as from one or more decks of physical playing cards (step S3). The one or more decks of cards preferably comprise 52 card decks where the cards have a front and a back, wherein the front or face thereof (but not the back) displays card rank and suit indicia comprising the suits Hearts, Diamonds, Spades, and Clubs, with the ranks (from lowest to highest) 2-10, Jack, Queen, and King, and where an Ace may be the lowest-ranked card when in sequence with a 2 or can be the highest-ranked card in a sequence with a K.

In one embodiment, a set of cards is dealt to each player and to the dealer. In one embodiment, each set of player cards comprises seven (7) cards and the set of dealer cards comprises seven (7) cards. In a preferred embodiment, a set of community cards is also dealt. The set of community cards may comprise three (3) cards. The cards may be dealt in a variety of manners. In the case of a gaming machine, the cards may be generated via random selection and displayed as video images. In the case of a table, the cards may be dealt (such as by the dealer) from a deck or set of physical playing cards, including from a shoe, or from an automatic shuffler.

Where multiple players are playing the game, a different set of cards is dealt to each player, but only a single set of cards is dealt to the dealer. The set of dealer cards may be dealt to the dealer hand area 43 of the dealer position 28 and the sets of player cards may be dealt to the player hand areas 42 of the player positions 30.

Upon receiving the player hand, each player then determines, such as by an inspection of their set of player cards, whether to fold or place a Play wager (step S4) (such as by placing one or more chips at the play wager location 48 of the game table). In one embodiment, the Play wager must be larger than a specified minimum amount, or smaller than a specified maximum amount. In a preferred embodiment, the play wager must be larger than the player's ante wager by a specified amount, such as two to four times the player's ante wager. If the player folds, the player loses their ante wager (step S11). In one embodiment, a player may be required to fold if the cards in the set of their player cards do not form a Straight hand (e.g. consecutively ranked cards) of a minimum number of cards, such as two cards (e.g. the player may be required to have a “qualifying hand” in order to continue the game).

If the player places a Play wager, the sets of dealer and player cards are evaluated (step S5, S6.2). In one embodiment, the object of the game is for each player and the dealer to form the highest possible “Straight” hand from the cards in their set of cards, e.g. the hand with the greatest number of consecutively ranked cards having the highest rank (wherein a larger group of consecutively ranked cards always outranks a smaller group of consecutively ranked cards, and as between two groups of the same number of consecutively ranked cards, the group with the card having the highest rank is the higher-ranked group) and the outcome of the game (relative to the Ante and Play wager) is determined with reference to the “Straight” hands of each player and the dealer.

In one embodiment, the outcome of the game is determined at least partially with reference to whether the dealer's Straight hand qualifies. In one embodiment, the dealer's hand only qualifies if it comprises at least a three-card Ace-Two-Three Straight. If the dealer's hand does not qualify, then the outcome of the game may be declared winning as to the player and a first award may be awarded to the player. In one embodiment, the player's Ante wager is declared to be winning and is resolved or paid at 1:1 (e.g. the player's wager is returned with an equal amount of winnings), and the player's Play wager is a push (e.g. is not winning or losing and is returned to the player) (step S6.1).

If the dealer's hand does qualify, then the player's Straight hand is compared to the dealer's Straight hand to determine the highest-ranking Straight (step S6.2). The player's hand is losing if the dealer's Straight hand outranks the player's Straight hand, in which case the player loses their Ante wager and Play wager (step S11). If the player's Straight hand and the dealer's Straight hand tie (are of equal rank), then the outcome of the player's Ante wager and Play wager is preferably a push, and the Ante wager and Play wager are returned to the player (step S7.2). If the player's Straight hand outranks the dealer's Straight hand, the player's hand is determined or declared to be winning and the player is preferably awarded a second award. In one embodiment, the player's Straight hand may be evaluated to determine whether the player's hand contains a Straight with 6 or 7 cards (step S7.1), wherein if the player's hand does not contain a Straight with 6 or 7 cards, then the player is awarded a second award at a rate of 1:1 of both their Ante wager and Play wager (step S8.1) and wherein if the player's hand does contain a Straight with 6 or 7 cards, then the player is awarded a second award a rate of 1:1 of their Ante wager, and 2:1 of their Play wager (step S8.2).

If the player also placed one or more side wagers, the one or more side wagers are resolved (preferably after the resolution of the ante and play wagers). As indicated above, in a preferred embodiment, the side wagers of all players are resolved, regardless of whether the player folded or placed a Play wager, and regardless of the outcome of any player's Ante wager and Play wager.

In one embodiment, the side wagers are resolve with reference to the set of player cards or the set of player cards plus one or more of the community cards, with reference to predetermined winning criteria for that side wager (step S9). If the player wins a side wager, then the player is preferably awarded a side wager award for that side wager (step S10).

In one embodiment, an optional side wager may be referred to as a “Second Chance Straight Flush” side wager, and is won if the cards in the set of player cards and the cards in the set of community cards (in any combination) comprise a predetermined winning combination of cards, and preferably a Straight Flush (cards having a sequential rank and being all of the same suit) of a minimum of three (3) cards. In such event, the player may be awarded a Second Chance wager award.

Table 1 sets forth preferred pay tables for winning hands and associated awards (where the pay table used in the game may be selected from one of the pay tables defined in Table 1) for the Second Chance Straight Flush side wager (and wherein hands that are not winning are losing).

TABLE 1
Second Chance Pay Tables

| Straight Flush | | | | | |
|---|---|---|---|---|---|
| Length | Paytable 1 | Paytable 2 | Paytable 3 | Paytable 4 | Paytable 5 |
| 10 | 5,000 to 1 | 100,000 to 1 | 10,000 to 1 | 10,000 to 1 | 1,000 to 1 |
| 9 | 5,000 to 1 | 25,000 to 1 | 5,000 to 1 | 5,000 to 1 | 1,000 to 1 |
| 8 | 5,000 to 1 | 5,000 to 1 | 2,000 to 1 | 2,000 to 1 | 1,000 to 1 |
| 7 | 500 to 1 | 1,000 to 1 | 1,000 to 1 | 1,000 to 1 | 1,000 to 1 |
| 6 | 50 to 1 | 250 to 1 | 100 to 1 | 400 to 1 | 500 to 1 |
| 5 | 25 to 1 | 50 to 1 | 20 to 1 | 50 to 1 | 50 to 1 |
| 4 | 10 to 1 | 10 to 1 | 10 to 1 | 20 to 1 | 20 to 1 |
| 3 | 2 to 1 | 1 to 1 | 2 to 1 | Loss | Loss |
| Less than 3 | Loss | Loss | Loss | Loss | Loss |

In one embodiment, an optional side wager may be referred to as a “Straight Flush” side wager, as is won if the cards in the set of player card comprise a predetermined combination of cards, and preferably a Straight Flush of a minimum of three (3) cards.

Table 2 sets forth preferred pay tables for winning hands and associated awards (wherein the pay table used in the game may be selected from one of the pay tables defined in Table 2), for the Straight Flush side wager (and wherein hands that are not winning are losing).

TABLE 2
Straight Flush Pay Tables

| Straight Flush | | | | |
|---|---|---|---|---|
| Length | Paytable 1 | Paytable 2 | Paytable 3 | Paytable 4 |
| 7 | 5,000 to 1 | 10,000 to 1 | 50,000 to 1 | 100,000 to 1 |
| 6 | 500 to 1 | 1,000 to 1 | 5,000 to 1 | 10,000 to 1 |
| 5 | 100 to 1 | 300 to 1 | 500 to 1 | 1,000 to 1 |
| 4 | 25 to 1 | 30 to 1 | 50 to 1 | 100 to 1 |
| 3 | 10 to 1 | 10 to 1 | 5 to 1 | Loss |
| Less than 3 | Loss | Loss | Loss | Loss |

In one embodiment, an optional side wager may be referred to as a “Straight Flush Progressive” side wager, as is won if the cards in the set of player card comprise a predetermined combination of cards, and preferably a Straight Flush of a minimum of four (4) cards

Table 3 sets forth preferred pay tables for winning hands and associated awards (wherein the pay table used in the game may be selected from one of the pay tables defined in Table 3), for the Straight Flush Progressive side wager (and wherein hands that are not winning are losing).

TABLE 3
Straight Flush Progressive Pay Tables

| Hand | Paytable 1 | Paytable 2 | Paytable 3 |
|---|---|---|---|
| 7-Card Royal Flush | 100% of Progressive | 100% of Progressive | 100% of Progressive |
| 7-Card Straight Flush | 50,000 for 1 | 100% of Progressive | 100% of Progressive |
| 6-Card Royal Flush | 20,000 for 1 | 20,000 for 1 | 6,000 for 1 |
| 6-Card Straight Flush | 5,000 for 1 | 5,000 for 1 | 6,000 for 1 |
| 5-Card Royal Flush | 2,000 for 1 | 2,000 for 1 | 600 for 1 |
| 5-Card Straight Flush | 500 for 1 | 500 for 1 | 600 for 1 |
| 4-Card Royal Flush | 200 for 1 | 200 for 1 | 60 for 1 |
| 4-Card Straight Flush | 50 for 1 | 50 for 1 | 60 for 1 |
| Hand | Paytable 4 | Paytable 5 | Paytable 6 |
| 7-Card Royal Flush | 100% of Progressive | 100% of Progressive | 100% of Progressive |
| 7-Card Straight Flush | 100% of Progressive | 100% of Progressive | 100% of Progressive |
| 6-Card Royal Flush | 100% of Progressive | 100% of Progressive | 100% of Progressive |
| 6-Card Straight Flush | 5,000 for 1 | 10,000 for 1 | 100% of Progressive s |
| 5-Card Royal Flush | 2,000 for 1 | 2,500 for 1 | 1,000 for 1 |
| 5-Card Straight Flush | 500 for 1 | 1,000 for 1 | 500 for 1 |
| 4-Card Royal Flush | 200 for 1 | 100 for 1 | 100 for 1 |
| 4-Card Straight Flush | 50 for 1 | Loss | 50 for 1 |

| Hand | Paytable 7 | Paytable 8 |
|---|---|---|
| 7-Card Royal Flush | 100% of Progressive | 100% of Progressive |
| 7-Card Straight Flush | 100% of Progressive | 100% of Progressive |
| 6-Card Royal Flush | 100% of Progressive | 100% of Progressive |
| 6-Card Straight Flush | 100% of Progressive | 100% of Progressive |
| 5-Card Royal Flush | 100% of Progressive | 100% of Progressive |
| 5-Card Straight Flush | 500 for 1 | 1,000 for 1 |
| 4-Card Royal Flush | 150 for 1 | 200 for 1 |
| 4-Card Straight Flush | 50 for 1 | Loss |

In one embodiment, the progressive jackpot for side wagers have a starting/seed value or reset value (after won). One example of seed values and increment rates the portion of each Straight Flush Progressive side wager that is paid to the progressive pool is as follows, wherein the seed values are based upon a $1 side wager and would be scaled according to other wager sizes:

TABLE 4
Straight Flush Progressive - Progressive Configurations

| Paytable # | Seed Value | Increment Rate |
|---|---|---|
| 1 | $200,000 | 20.00% |
| 2 | $100,000 | 20.00% |
| 3 | $60,000 | 25.00% |
| 4 | $20,000 | 20.00% |
| 5 | $25,000 | 20.00% |
| 6 | $10,000 | 20.00% |
| 7 | $1,500 | 30.00% |
| 8 | $5,000 | 20.00% |

In one embodiment, relative to the pay tables noted above, progressive amounts are paid “for 1” and not “to 1”, wherein the player is paid winnings in the amount of the progressive value but their side wager is not returned to them.

Winnings might be awarded in manners other than via pay tables. For example, a player may be awarded side wager winnings based upon an award selection event such as a spin of an award wheel. For example, referring to FIG. 1, in one embodiment an award wheel may be displayed graphically on the display 36 at the game table 20. Each player who receiving a winning side wager outcome is allowed to spin the wheel. As indicated above, in one embodiment, an input receiving device 32 may be activated. The player may then wave their hand or provide input to the input receiving device 32. The table controller 100 may then cause the display 36 to display a graphical representation of a spinning wheel that stops at a selected segment which corresponds to define the outcome of the wheel spin, and thus indicate the award which is awarded to the player. In such a configuration, the wheel spaces may display various awards, where those awards might vary depending upon the particular winning side wager outcome which the player received.

In one embodiment, the virtual wheel may be configured with segments with associated awards and the probability of a particular segment being selected may be weighted. In the wheel spin event, a random number generator or the like may be used to generate a random number which is then compared to a lookup table of outcomes. The selected outcome corresponds to a segment having an assigned award. The controller may then cause the display 36 to display a wheel spin in which the wheel stops at the selected segment. In this configuration, certain outcomes or awards are more likely to occur than others

Of course, the wheel spin event could be implemented by spinning a physical spinning wheel, such as where the stopping position of the wheel relative to a pointer or other selector is controlled, such as via a motor. The award selection event might also be represented by other than a wheel spin, but by other events.

Winnings (for winning game wagers or side wager wagers) might be paid in the form of chips, electronic credits, or the like. The player might cash-out electronic credits to a printed ticket or the like, such as printed and issued by a printer at a game table or device. The player might then take that ticket to a cashier station or window for redemption, such as conversion to monetary funds. Likewise, a player might cash out chips in a similar manner.

In one embodiment, the above-referenced pay tables might be displayed to players using the table display 36 or using the printing on the felt of the playing surface 22. The displayed information might include, for example, current award values (which amounts may change over time and thus be updated over time, such as where the jackpots are progressive). In one embodiment, as noted above, the dealer might use a dealer control, such as the touch screen 38, to activate the base game wagering areas 44,46 and side wager areas 48,50 at the start of the game, to receive player bets. In one embodiment, the players may be paid electronic credit as their award, while in other embodiments, as noted above, a player might be awarded chips.

In one embodiment, the game may offer one or more optional side wager opportunities, such as preferably all three of the side wagers detailed above. The player may then optionally place and play one or more of the optional side wagers, such as any combination of 1, 2 or all 3 of the side wagers described above.

In one variant of the game, the community cards may be dealt face down and are only revealed after player's have either folded or placed their Play wagers. In other embodiment, the community cards may only be dealt after that step, or might only be dealt at all if at least one player placed a side wager that requires resolution with reference to the community cards (such as by at least one player placing a Second Chance Straight Flush side wager as described above).

In other embodiments of the invention, additional wagers might be required or certain wagers might be combined. Further, while the wagers or bets have been referred to as Ante and Play wagers or bets, they might be referred to as first and second wagers or by other terminology.

As indicated, the game of the invention may be implemented in various manners, such as via various gaming machines, devices, and/or systems. For example, the methods of gameplay and presentation may also be implemented via an electronic gaming machine or device. Such a gaming machine may have various configurations.

The gaming machine may be located at a casino (and as such may be referred to as a “casino gaming machine”). As described below, the gaming machine may be part of a gaming system, such as a casino gaming system which links two or more of the gaming machines or one or more gaming machines with other devices, such as one or more table games, kiosks, accounting systems or servers, progressive systems or servers, player tracking systems or servers or the like.

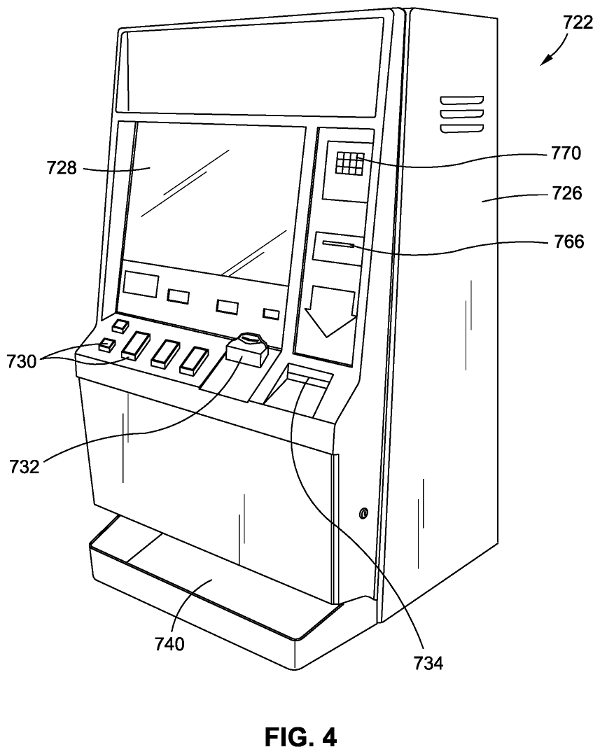

One configuration of a gaming machine 722 is illustrated in FIG. 4. The gaming machine 722 generally comprises a housing or cabinet 726 for supporting and/or enclosing various components required for the operation of the gaming machine. In the embodiment illustrated, the housing 726 includes a door located at a front thereof, the door capable of being moved between an open position that allows access to the interior, and a closed position in which access to the interior is generally prevented. The configuration of the gaming machine 722 may vary. In the embodiment illustrated, the gaming machine 722 has an “upright” configuration. However, the gaming machine 722 could have other configurations, shapes, or dimensions (such as being of a “slant”-type, “bar-top” or other configuration as is well known to those of skill in the art).

The gaming machine 722 preferably includes at least one first display device 728 configured to display game information. The display device 728 may comprise an electronic video display such as a cathode ray tube (CRT), high-resolution flat-panel liquid crystal display (LCD), projection LCD, plasma display, field emission display, digital micro-mirror display (DMD), digital light processing display (DLP), LCD touchscreen, a light-emitting display (LED) or other suitable displays now known or later developed, in a variety of resolutions, sizes, and formats (e.g. 4:3, widescreen or the like). The display device 728 may be capable of projecting or displaying a wide variety of information, including images, symbols, and other indicia or information associated with gameplay, game promotion, or other events. The gaming machine 722 might include more than one display device, such as a main or first display device 28 and a secondary display device. The two or more display devices might be associated with the housing or the gaming machine 722 might also include a top box or other portion which includes the one or more second display devices. Also, the gaming machine 722 might include side displays (such as mounted to the exterior of the housing 726) and might include multiple displays of differing sizes.

The gaming machine 722 is preferably configured to present one or more games upon a player making a monetary payment or wager. In this regard, as described in more detail below, the gaming machine 722 includes mechanisms or means for accepting wagers.

In one embodiment, as noted above, certain base game outcomes and side wager outcomes (but preferably not all outcomes) may be designated as winning outcomes (the non-winning outcomes may be referred to as losing outcomes) and awards may be provided for winning outcomes, such as monetary payments (or representations thereof, such as prize of credits) as detailed herein. As detailed below, the gaming machine 722 preferably includes a mechanism or means for returning unused monetary funds and/or dispensing winnings to a player.

The gaming machine 722 preferably includes one or more player input devices 730 (such as input buttons, plunger mechanisms, a touch-screen display, joystick, touch-pad, or the like). These one or more devices 730 may be utilized by the player to facilitate gameplay, such as by providing input or instruction to the gaming machine 722. For example, such input devices 730 may be utilized by a player to place a wager, cause the gaming machine 22 to initiate a game, to “cash-out” of the gaming machine, or to provide various other inputs.

In one preferred embodiment, the gaming machine 722 includes at least one microprocessor or controller for controlling the gaming machine, including receiving player input and sending output signals for controlling the various components or peripheral devices of the machine 722 (such as generating game information for display by the display devices). The controller may be arranged to receive information regarding funds provided by a player to the gaming machine 722, receive input such as a purchase/bet signal when a purchase/bet button is depressed, and receive other inputs from a player. The controller may be arranged to generate information regarding a game, such as generating game information for display by the at least one display device (such as information comprising nonconventional playing cards which are dealt, as described above), for determining winning or losing game outcomes and for displaying information regarding awards for winning game wagers and side wagers, among other things.

The controller may be configured to execute machine-readable code or “software” or otherwise process information, such as obtained from a remote server. Software or other instructions may be stored at a memory or data storage device, e.g. in a fixed or non-transitory configuration. The memory may also store other information or data, such as data stored in a table or other forms (including, but not limited to look-up tables, pay tables, and other information including tracked gameplay information). The gaming machine 722 may also include one or more random number generators for generating random numbers (such as implemented by a random number generator software module stored in the memory and executable by the processor), such as for use in selecting the nonconventional playing cards and for randomly presenting the game (e.g. whereby the game is presented in a manner in which the player cannot control the outcome) or pseudo-random fashion (e.g. such as where the game includes a skill component which can affect the outcome of the game). One embodiment of a random RNG engine, RNGCryptoServiceProvider Class, by Microsoft, is set forth below in Table 5.

TABLE 5

Language: c# .net
Code snippet:

//
// Summary:
// Fills an array of bytes with a cryptographically strong sequence of random

values.

//
// Parameters:
// data:
// The array to fill with a cryptographically strong sequence of random values.
//
// Exceptions:
// T:System.Security.Cryptography.CryptographicException:
// The cryptographic service provider (CSP) cannot be acquired.
//
// T:System.ArgumentNullException:
// data is null.

static RNGCryptoServiceProvider _crypto = new RNGCryptoServiceProvider( );
var bytes = new byte[1];
_crypto.GetBytes(bytes);

Preferably, the controller is configured to execute machine-readable code or instructions (e.g. software) which are configured to implement the game. In this regard, the gaming machine 722 is specially configured to present the game of the invention via specific software and/or hardware which causes the gaming machine to operate uniquely. For example, the controller of the gaming machine 722 may be configured to detect a wager, such as a signal from a player's depressing of an ante wager button. Upon such an event and/or the player otherwise signaling the gaming machine to present the game, the controller may be configured to cause the at least one display 728 to display unique information, such as a unique graphical interface or unique game display, including images of playing cards (and player and/or dealer hands and community cards) or other game information. The controller may accept input from a player of game inputs via the one or more player input devices of the gaming machine 722. As indicated above, the machine-readable code may be configured in various manners, such as by having various “modules” of software that are designed to implement specific features of the gameplay or game presentation.

The gaming machine 722 may be configured to generate and present games in a stand-alone manner or it may be in communication with one or more external devices or systems at one or more times. The gaming machine 722 might communicate with one or more of such external devices or systems via one or more communication ports or other interface devices. These ports or interface devices may be configured to implement various communication protocols (including proprietary protocols) and communicate via wireless, wired or other communication link. For example, the gaming machine 722 may be configured as a server-based device and obtain game code or game outcome information from a remote game server (in which event the gaming machine controller may receive game information from the server, such as game outcome information, and use that server-generated information to present the game at the gaming machine).

As indicated, the gaming machine 722 is configured to present one or more wagering games. The gaming machine 722 is preferably configured to accept wagers. Thus, the gaming machine 722 preferably includes a mechanism or means for accepting monetary value. Such might comprise a means for accepting coins and/or tokens 732. Of course, associated coin/token reading/verifying devices and coin/token storage devices may be associated with the gaming machine 722 if it is configured to accept coins and/or tokens. Likewise, the gaming machine 722 might include a mechanism or means for accepting paper currency and/or other media such as tickets 734. Of course, in such an event the gaming machine 722 may further be configured with one or more paper currency and/or ticket storage devices, such as cash boxes, and other paper currency or media handling devices (including transport devices).

The gaming machine 722 might also be configured to read FOBs, magnetic stripe cards, or other media having data associated therewith and via which value or funds may be associated with the gaming machine 722. The mechanism for accepting monetary value might also comprise hardware and/or software that allows a player to transfer (such as electronically) funds from an account, such as a casino wagering account, or a bank or other financial institution account. Such a mechanism might include a communication interface that permits the gaming machine to communicate with a mobile phone, PDA, tablet, or other electronic devices of the player (such as via a physical interface or wired or wireless communications, such as to enable the transfer of funds from the player to the gaming machine or system.

When the player associates funds with the gaming machine or an associated system, a credit balance is generated. The credit balance may comprise a plurality of monetary value credits. The player may wager some or all of the associated monetary value, such as by wagering one or more of the credits associated with the credit balance. For example, the player might provide input to a wager button or touch screen interface to wager a certain number of credits (such as “Bet 1 Credit”, “Bet 5 Credits”, “Bet Maximum Credits” or other options). Such wager input options may allow the player to wager on the base game and optionally place the side wagers. In one embodiment, when the player's wager is received, the player's credit balance is reduced by the number of wagered credits. The player might then provide a separate input to begin the game. In other embodiment, the player might select a “play game” input, which input is taken to comprise both an instruction to place a wager (such as of a pre-set or pre-selected number of credits) and to start the game. Of course, other configurations may be implemented for accepting monetary value from the player and for allowing the player to place a wager from the associated monetary value.

In one embodiment, the gaming machine 722 is configured to award winnings for one or more winning wagering game outcomes. Such winnings may be represented as credits, points, or the like. In one embodiment, the player may “cash-out” and thus remove previously associated funds and any awarded winnings or such may otherwise be paid to the player. These winnings may be associated with the player's credit balance, thus increasing the player's credit balance.

In one embodiment, the player may provide an input to the gaming machine 722 to indicate their desire to cash out, such as by selecting a “cash-out” button or touch screen feature or providing other input. In response, a monetary value represented by the player's credit balance or the like is preferably paid, transferred, or otherwise provided to the player. For example, upon an award or at cash-out, associated funds may be paid to the player by the gaming machine 722 dispensing coins to a coin tray 740. In another embodiment, funds may be issued by dispensing paper currency or other media. In yet another embodiment, a player may be issued a media, such as a printed ticket, which ticket represents the value that was paid or cashed out of the machine. The aspects of gaming machine “ticketing” systems are well known. One such system is described in U.S. Pat. No. 6,048,269 to Burns, which is incorporated herein in its entirety by reference. In yet another embodiment, the cash-out might result in the dispensing of a card or other media that stores or represents the cashed-out funds, such as by writing funds information to a magnetic stripe of a card which is inserted into a media writer of the gaming machine or dispensed from the machine. In this regard, the gaming machine 722 may include one or more media printers or writers 48. In other embodiments, the cash-out mechanism may result in the funds value being transferred to an external device or account, such as a player's casino account (such as associated with a casino server), a remote bank or other financial accounts, or an electronic device such as a player's phone, PDA or tablet.

The gaming machine 722 may also include a player tracking device, such as a card reader 766 and/or an associated keypad 770 or other input devices (such as a touch screen display). Such player tracking devices are well known and may permit the game operator to track the play of players of the gaming machine. The tracked play may be utilized to offer player bonuses or awards.

The main game controller or processor may communicate with several of the peripheral devices via one or more intermediary controllers. For example, some of the peripheral devices might comprise USB type or enabled devices that are controlled by an intermediary USB controller.

A casino may have numerous such gaming machines 722, such as located on a casino floor or in other locations. Of course, such gaming machines 722 might be used in other environments, such as an airport, a bar or tavern, or other locations.

It will be appreciated that the gaming machine illustrated in FIG. 4 is only exemplary of one embodiment of a gaming machine. For example, it is possible for the gaming machine to have various other configurations, including different shapes and styles and having different components than as just described.

For example, instead of comprising a casino-style gaming machine, the game of the invention can be presented on a computing device, including at a home or office computer or a player's mobile electronic device such as a PDA, phone, or the like. In one embodiment, a player might log in to a casino server and the controller of the casino server may cause game information to be delivered to the player's computer via a communication link and then be displayed on a display of the player's computer. The communication link might comprise or include the Internet, a casino network such as a wired or wireless LAN, or combinations of public and/or private networks including wired and/or wireless links. In such a configuration it will be noted that the term “controller” may comprise more than one device. For example, in a server-based environment, a controller at a server may generate game information and transmit that information to a local controller at a gaming machine or a player's computer, or other electronic devices. The local controller at the gaming machine or the player's computer or other electronic devices may then cause game information to be displayed on one or more associated displays.

The gaming machine 722 may, as noted above, be part of a system that includes other devices. For example, the gaming machine 722 may communicate with one or more casino systems, such as a player tracking server or system, an accounting system or server, a ticketing system, a bonusing system, a tournament system, other gaming machines, and external devices.

Such a gaming machine 722 might be used, for example, to present the above-referenced game to one or more players in a configuration where the dealer is essentially automated.

The invention has various advantages. One advantage of the game is that it is simple to play: a player needs to only evaluate their cards for a Straight hand. The player does not need to decide which cards to discard and does not need to learn or evaluate all of the various hands of traditional poker. The game can also be played quickly as there is no discard/deal sequence. Another advantage of the invention is that it offers the player side wager opportunities which can be won even if the base hand is not winning or even if the player folds. Advantages of the devices and systems of the invention comprise the ability to present a game where each player may make multiple wagers (and where the players may make wagers which are different from one another, including in size), and which facilitates automation of the tracking of the different wagers and associated awards (which would otherwise be practically impossible for a dealer to do manually based solely upon players sliding out chips to place wagers). Other advantages to the game include that it can be played in both single player and multi-player formats without changing the game (e.g. a player can play the game as presented at a gaming machine and can then play the same game at a gaming table without a change in the game rules).

Another advantage to the game is that it offers one or more exciting, but optional, side wagers. In a preferred variant, the outcome of the base portion of the game (which resolves the Ante and Play wager) is independent of the side wagers—e.g. regardless of whether the player wins or loses the base portion of the game, they have the opportunity to win the one or more side wagers that they have placed. In a preferred embodiment, the side wagers are easy for the player to play and assess, such as by only being won if certain combinations of cards form a particular hand, and preferably a Straight Flush hand (thus eliminating the need for the player and/or dealer to assess a large number of hands, such as all poker hands, for potential winning outcomes).

An advantage to the game is that it is enticing to both the player and the house. The player has the opportunity to win large winning amounts (e.g. the game is relatively volatile), including progressive jackpots, and with the pay tables set forth above, the average return to the player for the game is 98.94%. At the same time, the house edge is 2.74% (per initial wager), thus giving the house a return for presenting the game.

It will be understood that the above-described arrangements of apparatus and the method therefrom are merely illustrative of applications of the principles of this invention and many other embodiments and modifications may be made without departing from the spirit and scope of the invention as defined in the claims.

What is claimed is:

1. A gaming machine configured to generate game information for presenting a wagering game to a player comprising:
a monetary funds accepting mechanism for accepting monetary funds in creating a player credit balance;
at least one display device;
at least one player input device;
a memory device;
a controller; and
machine-readable code stored in said memory device and executable by said controller and configured to cause said controller to accept from said player, by said at least one player input device, an ante wager from said credit balance and, optionally, at least one side wager from said credit balance;
machine-readable code stored in said memory device and executable by said controller and configured to cause said controller to generate a set of player cards comprising seven cards and a set of dealer cards comprising seven cards and to cause said controller to cause said at least one display device to display said set of player cards to said player;
machine-readable code stored in said memory device and executable by said controller and configured to cause said controller to receive an election from said at least one player to place a play wager;
machine-readable code stored in said memory device and executable by said controller and configured to cause said controller to determine whether said set of dealer cards define a qualifying hand;
machine-readable code stored in said memory device and executable by said controller and configured to cause said controller to award a first award to said player when said player placed said play wager and said set of dealer cards do not define a qualifying hand, and increase said credit balance based upon said first award;
machine-readable code stored in said memory device and executable by said controller and configured to cause said controller to, when said player placed said play wager and said set of dealer cards define a qualifying hand, determine an outcome of said player's ante and play wager based solely upon a highest Straight formed from cards in said set of player cards and a highest Straight formed from cards in said set of dealer cards, wherein said controller is configured to award a second award to said player when said highest Straight formed from said cards in said set of player cards has a higher rank than said highest Straight formed from said cards in said set of dealer cards, and increase said credit balance based upon said second award; and
machine-readable code stored in said memory device and executable by said controller and configured to cause said controller to determine an outcome of each side wager placed by said player with reference to at least said set of player cards and award a side bet award for each winning side wager.

2. The gaming machine in accordance with claim 1 wherein said machine-readable code stored in said memory device and executable by said controller is configured to cause said controller to return said player's ante and play wagers when said highest Straight formed from said cards in said set of player cards is of the same rank as said highest Straight formed from said cards in said set of dealer cards.

3. The gaming machine of claim 1, wherein said qualifying hand comprises a three-card Ace-Two-Three Straight or better.

4. The gaming machine of claim 1, wherein said player is only permitted to place said play wager when said set of player cards comprise a qualifying hand.

5. The gaming machine of claim 4, wherein said qualifying hand comprises a Straight of at least two cards.

6. The gaming machine of claim 1, wherein said second award is a first amount when said Straight hand formed from said cards in said set of player cards comprises six (6) or more cards and is a second amount when said Straight hand formed from said cards in said set of player cards comprises fewer than six (6) cards.

7. The gaming machine of claim 1, further comprising:
machine-readable code stored in said memory device and executable by said controller and configured to cause generate a set of community cards comprising three community cards and to cause said at least one display device to display said set of community cards; and
machine-readable code stored in said memory device and executable by said controller to cause said controller to, based upon receipt of a first side wager by said player, determine an outcome of said first side wager with reference to cards in said set of player cards and said set of community cards.

8. The gaming machine of claim 7, wherein said first side wager is determined to be winning when said cards in said set of player cards and said set of community cards form a Straight Flush of a minimum of 3 cards.

9. The gaming machine of claim 1, further comprising machine-readable code stored in said memory device and executable by said controller to cause said controller to, based upon receipt of a first side wager by said player, determine said first side wager to be winning when said cards in said set of player cards form a Straight Flush of a minimum of 3 cards.

10. The gaming machine of claim 1, wherein said machine-readable code stored in said memory device and executable by said controller is configured to cause said controller to:
receive an optional first side wager from said player, determine said first side wager to be winning and award a first side wager award when said cards in said set of player cards form a Straight Flush of a minimum of 3 cards;
receive an optional second side wager from said player, determine said second side wager to be winning and award a progressive award when said cards in said set of player cards form a Straight Flush of a minimum of 4 cards; and
receive an optional third side wager from said player, determine said third side wager to be winning and award a third side wager award when said cards in said set of player cards and cards in a set of deal community cards form a Straight Flush of a minimum of 3 cards.

11. A method of presenting a game to at least one player at a game table comprising the steps of:
receiving an ante wager from said player at an ante wager location via at least one input receiving device of said game table;
receiving an election of one or more optional side wagers from said player by receiving one or more optional side wagers at one or more side wager locations via at least one input receiving device of said game table;
dealing a player hand to said player comprising seven cards to a player card location from at least one deck of physical playing cards;
dealing a dealer hand comprising seven cards to a dealer card location from said at least one deck of physical playing cards;
receiving an election of a play bet by receiving an optional play wager from said player at a player wager location via at least one input receiving device of said game table, such that (1) when no said optional play wager is received, said player's ante wager is losing, and (2) when said optional play wager is received, determining an outcome of said player's ante wager and play wager as follows:
determining if said dealer hand qualifies;
when said dealer hand does not qualify, awarding a first award to said player;
when said dealer hand qualifies, determining an outcome of said player's ante and play wager with reference solely to a highest Straight hand formed from said player hand and said highest Straight hand formed from said dealer hand and:
awarding a second award to said player when said highest Straight hand formed from said player hand outranks said highest Straight hand formed from said dealer hand; and
determining an outcome of each of said one or more optional side wagers placed by said player with reference to at least the player's hand.

12. The method of claim 11, wherein said dealer hand qualifies when said dealer hand comprises a three-card Ace-Two-Three Straight or better.

13. The method of claim 11, wherein said player is only permitted to place said play wager when said set of player card comprise a qualifying hand.

14. The method of claim 13, wherein said qualifying hand comprises a Straight of at least two cards.

15. The method of claim 11, wherein said optional side wager comprises a first side wager and further comprising dealing a set of community cards comprising three cards to a community card location from at least one deck of physical playing cards and determining an outcome of said first side wager based upon said player hand and said set of community cards.

16. The method of claim 15, wherein said first side wager is determined to be winning when said player hand and said set of community cards form a Straight Flush of a minimum of 3 cards.

17. The method of claim 16, further comprising awarding a first side wager award when said first side wage is determined to be winning, based upon at least one of the following pay tables:

| Straight Flush | Paytable 1 | Paytable 2 | Paytable 3 | Paytable 4 | Paytable 5 |
|---|---|---|---|---|---|
| 10 cards | 5,000 to 1 | 100,000 to 1 | 10,000 to 1 | 10,000 to 1 | 1,000 to 1 |
| 9 cards | 5,000 to 1 | 25,000 to 1 | 5,000 to 1 | 5,000 to 1 | 1,000 to 1 |
| 8 cards | 5,000 to 1 | 5,000 to 1 | 2,000 to 1 | 2,000 to 1 | 1,000 to 1 |
| 7 cards | 500 to 1 | 1,000 to 1 | 1,000 to 1 | 1,000 to 1 | 1,000 to 1 |
| 6 cards | 50 to 1 | 250 to 1 | 100 to 1 | 400 to 1 | 500 to 1 |
| 5 cards | 25 to 1 | 50 to 1 | 20 to 1 | 50 to 1 | 50 to 1 |
| 4 cards | 10 to 1 | 10 to 1 | 10 to 1 | 20 to 1 | 20 to 1 |
| 3 cards | 2 to 1 | 1 to 1 | 2 to 1 | Loss | Loss |
| Less than 3 cards | Loss | Loss | Loss | Loss | Loss |

18. The method of claim 11, wherein said optional side wager comprises a second side wager and further comprising determining an outcome of said second side wager to be winning when said player hand comprises a Straight Flush of a minimum of 3 cards and awarding a second side wager award when said second side wager is winning, based upon at least one of the following pay tables:

| Straight Flush | Paytable 1 | Paytable 2 | Paytable 3 | Paytable 4 |
|---|---|---|---|---|
| 7 cards | 5,000 to 1 | 10,000 to 1 | 50,000 to 1 | 100,000 to 1 |
| 6 cards | 500 to 1 | 1,000 to 1 | 5,000 to 1 | 10,000 to 1 |
| 5 cards | 100 to 1 | 300 to 1 | 500 to 1 | 1,000 to 1 |
| 4 cards | 25 to 1 | 30 to 1 | 50 to 1 | 100 to 1 |
| 3 cards | 10 to 1 | 10 to 1 | 5 to 1 | Loss |
| Less than 3 cards | Loss | Loss | Loss | Loss |

19. The method of claim 11, wherein said optional side wager comprises a third side wager and further comprising determining an outcome of said third side wager to be winning when said player hand comprises a Straight Flush of a minimum of 4 cards and awarding a third side wager award when said third side wager is winning, based upon at least one of the following pay tables:

| Hand | Paytable 1 | Paytable 2 | Paytable 3 |
|---|---|---|---|
| 7-Card Royal Flush | 100% of Progressive | 100% of Progressive | 100% of Progressive |
| 7-Card Straight Flush | 50,000 for 1 | 100% of Progressive | 100% of Progressive |
| 6-Card Royal Flush | 20,000 for 1 | 20,000 for 1 | 6,000 for 1 |
| 6-Card Straight Flush | 5,000 for 1 | 5,000 for 1 | 6,000 for 1 |
| 5-Card Royal Flush | 2,000 for 1 | 2,000 for 1 | 600 for 1 |
| 5-Card Straight Flush | 500 for 1 | 500 for 1 | 600 for 1 |
| 4-Card Royal Flush | 200 for 1 | 200 for 1 | 60 for 1 |
| 4-Card Straight Flush | 50 for 1 | 50 for 1 | 60 for 1 |
| Hand | Paytable 4 | Paytable 5 | Paytable 6 |
| 7-Card Royal Flush | 100% of Progressive | 100% of Progressive | 100% of Progressive |
| 7-Card Straight Flush | 100% of Progressive | 100% of Progressive | 100% of Progressive |
| 6-Card Royal Flush | 100% of Progressive | 100% of Progressive | 100% of Progressive |
| 6-Card Straight Flush | 5,000 for 1 | 10,000 for 1 | 100% of Progressive |
| 5-Card Royal Flush | 2,000 for 1 | 2,500 for 1 | 1,000 for 1 |
| 5-Card Straight Flush | 500 for 1 | 1,000 for 1 | 500 for 1 |
| 4-Card Royal Flush | 200 for 1 | 100 for 1 | 100 for 1 |
| 4-Card Straight Flush | 50 for 1 | Loss | 50 for 1 |
| Hand | Paytable 7 | Paytable 8 |
|---|---|---|
| 7-Card Royal Flush | 100% of Progressive | 100% of Progressive |
| 7-Card Straight Flush | 100% of Progressive | 100% of Progressive |
| 6-Card Royal Flush | 100% of Progressive | 100% of Progressive |
| 6-Card Straight Flush | 100% of Progressive | 100% of Progressive |
| 5-Card Royal Flush | 100% of Progressive | 100% of Progressive |
| 5-Card Straight Flush | 500 for 1 | 1,000 for 1 |
| 4-Card Royal Flush | 150 for 1 | 200 for 1 |
| 4-Card Straight Flush | 50 for 1 | Loss |
